(19) United States
(12) Patent Application Publication
(10) Pub. No.: US 2012/0302436 A1
(43) Pub. Date: Nov. 29, 2012

(54) GRANULES COMPRISING SILICA AND TITANIA

(75) Inventors: Reinhard Vormberg, Neuberg (DE); Christian Schulze Isfort, Limeshain (DE); Nina Schuhardt, Grossostheim (DE); Juergen Meyer, Stockstadt (DE)

(73) Assignee: Evonik Degussa GmbH, Essen (DE)

(21) Appl. No.: 13/576,187

(22) PCT Filed: Mar. 9, 2011
(86) PCT No.: PCT/EP2011/053532

§ 371 Date: Jul. 31, 2012

(30) Foreign Application Priority Data
Apr. 6, 2010 (DE) 102010003652.8

(51) Int. Cl. B01J 21/08

(52) U.S. Cl. 502/242; 502/439

(57) ABSTRACT

A granulated material comprising a mixed silicon-titanium oxide powder, wherein a proportion of TiO₂ is from 70 to 98 wt %, a proportion of SiO₂ is from 2 to 30 wt %, and a sum of TiO₂ and SiO₂ is at least 98% by weight, and wherein: at room temperature, the TiO₂ proportion comprises rutile and more than 50% of anatase, the BET surface area is from 10 to 200 m²/g, and the volume of 2 to 50 nm pores is from 0.4 to 2.5 ml/g; and after heating at 900° C. for a period of 4 hours, the anatase proportion is more than 50% of the room temperature proportion, the BET surface area is at least 60% of the room temperature BET surface area, and the volume of 2 to 50 nm pores is at least 50% of the room temperature volume.

The invention relates to a granulated material which contains silicon dioxide and titanium dioxide and has a high stability of the BET surface area, of the pore volume and of the catalytic activity at high temperatures. The invention further relates to a process for producing the granulated material and its use as catalyst and catalyst support.

Three titanium dioxide phases, namely rutile, anatase and brookite, exist in nature. Anatase is often the main product of various synthetic routes such as sol-gel processes, hydrothermal processes, precipitation reactions or flame processes.

Uses of titanium dioxide as catalyst or catalyst support require high temperatures which lead to an irreversible transformation of anatase into rutile and can thus lead to a reduction in the catalytic, in particular photocatalytic, activity.

This situation can be improved, for example, by replacing titanium dioxide by mixed silicon-titanium oxides which have an improved thermal stability of the BET surface area.

Mixed silicon-titanium oxide powders can be prepared, for example, by a pyrogenic route. Here, a mixture of silicon tetrachloride and titanium tetrachloride is generally hydrolysed and/or oxidized in a flame. The flame can, for example, be produced by reaction of hydrogen and atmospheric oxygen. This forms the water necessary for hydrolysis of the chlorides. Thus, DE-A-2931810 claims a mixed silicon-titanium oxide powder which contains from 0.1 to 9.9% by weight of titanium dioxide.

EP-A-1553054 claims a mixed silicon-titanium oxide powder which has a BET surface area in the range from 20 to 200 m²/g and a titanium dioxide content of more than 10% by weight and less than 70% by weight. EP-A-595078 claims a mixed silicon-titanium oxide powder which contains from 70 to 99% by weight of titanium dioxide. EP-A-1752215 discloses a mixed silicon-titanium oxide powder having a BET surface area of from 5 to 300 m²/g and a titanium dioxide content of ≧99.0% by weight. EP-A-1321432 discloses a mixed silicon-titanium oxide powder which is prepared by flame hydrolysis and in which the weight ratio of silicon dioxide/titanium dioxide on the surface of the primary particles is greater than in the total primary particle. The weight ratio of SiO₂/TiO₂ can be from 0.01 to 99, based on the total primary particle, and the BET surface area can be from 10 to 300 m²/g.

In principle, all these powders can be used as catalyst or catalyst support. The powder disclosed in EP-A-595078, in particular, has a relatively high stability of the BET surface area on thermal treatment. However, this powder, like others in the prior art, has an unsatisfactory mechanical stability when used as catalyst or catalyst support. In addition, a reduction in the catalytic, in particular photocatalytic, activity can be observed under these conditions and can occur independently of the process to be catalyzed.

There is therefore the technical problem of providing a material which has good thermal and mechanical stability at high temperatures and displays a high catalytic activity.

The technical problem is solved by a granulated material comprising or consisting of one or more mixed silicon-titanium oxide powders, wherein the proportion

of titanium dioxide is from 70 to 98% by weight, preferably from 75 to 97% by weight, particularly preferably from 85 to 95.5% by weight,
that of silicon dioxide is from 2 to 30% by weight, preferably from 3 to 25% by weight, particularly preferably from 4.5 to 15% by weight, and the sum of the proportions is at least 98% by weight, preferably at least 99% by weight, particularly preferably at least 99.5% by weight, in each case based on the granulated material, and
a) at room temperature
a1) the proportion of titanium dioxide comprises or consists of the modifications rutile and anatase and the proportion of anatase, based on the titanium dioxide present, is more than 50%, preferably from 60 to 95%, particularly preferably from 65 to 85%,
a2) the BET surface area is from 10 to 200 m²/g, preferably from 40 to 150 m²/g,
a3) the volume of pores having a size of from 2 to 50 nm is from 0.4 to 2.5 ml/g and
   b) after heating at 900° C. for a period of 4 hours,
b1) the proportion of anatase is more than 50%, preferably from 60 to 100%, particularly preferably from 65 to 99%, of the proportion at room temperature,
b2) the BET surface area is at least 60%, preferably from 65 to 85%, of the BET surface area at room temperature,
b3) the volume of pores having a size of from 2 to 50 nm is at least 50%, preferably from 60 to 99%, particularly preferably from 65 to 95%, of the volume of pores having a size of from 2 to 50 nm at room temperature.

For the purposes of the present invention, room temperature is a temperature of 23° C.

The granulated material of the invention can preferably have an average granule diameter D₅₀ of from 10 to 200 μm. Particular preference is given to a range from 10 to 40 μm.

The invention further provides a process for producing the granulated material, in which a dispersion containing one or more mixed silicon-titanium oxide powders and water or an aqueous solution, is dried at temperatures of from 100 to 350° C. for a period of 12 hours to 5 days, and optionally subsequently milled and sieved so that the average granule diameter D₅₀ is from 10 to 200 μm. The granulated material obtained in this way has a very good mechanical stability and is thus ideally suitable as catalyst or catalyst support.

The dispersion can be produced using the dispersing apparatuses known to those skilled in the art. Preference is given to using rotor-stator apparatuses. The proportion of powder in the dispersion can be from 1 to 30% by weight. In general, the proportion of powder is from 5 to 20% by weight.

In a particular embodiment of the process, the water is removed from the dispersion by means of spray drying. It is known that the properties of a granulated material produced in this way depend, inter alia, on the density and the viscosity of the dispersion used and also the settings of the spray dryer, e.g. throughput and temperature. A person skilled in the art will be able to determine these parameters in the production of the granulated material of the invention by experimentation.

As aqueous solution it is possible to use, in particular, a solution containing one or more substances which lower the viscosity of the dispersion. These can be acids or bases. Mention may be made by way of example of hydrochloric acid, acetic acid, potassium hydroxide, ammonia and tetraalkylammonium hydroxides. Such substances which lower the viscosity can be used, in particular, when the solids content of the dispersion is high.

Ideally, fumed mixed silicon-titanium oxide powders are used in the process of the invention. For the purposes of the present invention, fumed means that the particles on which the powder is based are obtained by flame hydrolysis or flame oxidation or a mixed form of the two reactions. In the present case, the powders are “co-fumed” mixed oxide powders obtained by reacting the starting materials, for example silicon tetrachloride and titanium tetrachloride, with one another in the flame. This results in true mixed oxide particles, in contrast to physical mixtures. In the course of the reaction, primary particles are formed first and they subsequently grow together to produce aggregates. Here, the primary particles are largely or completely free of internal pores. However, the three-dimensional arrangement of the aggregates in the granulated material leads to a pore volume which is stable for catalytic processes even in the case of thermal treatment.

For the purposes of the invention, the process of the invention should also be able to be carried out using fumed mixed oxide powders which contain one or more further components based on noble metals or metal oxides. The proportion of these components can be up to 1% by weight, preferably from 10 to 1000 ppm, based on the mixed oxide powder. Possible further components are, in particular metals and metal oxides from the group consisting of Ag, Al, As, Au, B, Ba, Be, Bi, Ca, Cd, Ce, Co, Cr, Cs, Cu, Dy, Er, Eu, Fe, Ga, Gd, Ge, Hf, Ho, In, Ir, K, La, Li, Lu, Mg, Mn, Mo, Na, Nb, Nd, Ni, Os, P, Pb, Pd, Pm, Pr, Pt, Rb, Re, Rh, Ru, Sb, Sc, Sm, Sn, Sr, Ta, Tb, Tc, Tl, Tm, V, W, Y, Yb, Zn and Zr. Processes for preparing such powders are known, for example, from DE-A-19650500 or EP-A-1785395.

The invention further provides for the use of the granulated material as catalyst or catalyst support, in particular in processes in which water vapour is present or is formed.

### EXAMPLES

### Analytical Method

The pore volume of the pores having a size of from 2 to 50 nm is determined by the BJH method in accordance with DIN 66134. The BET surface area is determined in accordance with DIN 66131. The determination of the anatase content is carried out by X-ray diffraction.

### Starting Materials

The mixed silicon-titanium oxide powders P2-P5 are prepared by a method based on the process disclosed in U.S. Pat. No. 5,268,337. The physicochemical properties of these powders are shown in Table 1. In addition, a commercially available titanium dioxide powder without any SiO₂ content, powder P1, AEROXIDE® TiO₂ P25 from Evonik Degussa, is used for comparative purposes. The powder P2 containing 0.5% by weight of SiO₂ also serves for comparative purposes. The BET surface area is determined in accordance with DIN 66131, and the anatase content is determined from X-ray diffraction patterns.

The powders P1-P5 can contain proportions of chloride and possibly further impurities determined by the purity of the starting materials in addition to SiO₂ and TiO₂. The specification “≧” in the context of TiO₂ means that the proportion of TiO₂ can be from the value indicated to the stoichiometric value. In the case of the powder P2 the proportion of TiO₂ can thus be from 99.3 to 99.5% by weight.

Production of the Granulated Materials 100 g of one of the powders P1-P5 are in each case dispersed in 1 litre of distilled water by means of an Ultraturrax DI 25 for a period of 15 minutes at a rotational speed of 20 000 rpm. The water present is subsequently evaporated at 105° C. over a period of 48 hours. The residue is ground in a mortar and sieved.

The granulated materials G1-G5 obtained in this way have approximately the same values for the SiO₂ content, the TiO₂ content, the BET surface area and the proportion of anatase as the powders P1-P5. The average granule diameter is 30 μm.

### Stability of the Pore Volume

2.5 g portions of the resulting granulated materials G1-G5 are subjected to a particular temperature in an aluminium oxide boat in a muffle furnace for a period of 4 hours. The temperatures are 600° C., 700° C., 800° C. and 900° C.

In the examination of the properties of the granulated materials under hydrothermal conditions, an apparatus in which the granulated material is present in an oven through which a gas stream saturated with water vapour is passed at a pressure of 1.1 bar is used. The absolute moisture content is regulated to a value of 100±15 g of H₂O/m³ of gas stream.

### Result

Tables 2A and 2B show that in the case of the granulated materials according to the invention G3-G5 the pore volume of the pores having a size of from 2 to 50 nm decreases only insignificantly at temperatures during thermal treatment and hydrothermal treatment.

Tables 3A and 3B show that in the case of the granulated materials according to the invention G3-G5 the BET surface area decreases only insignificantly during thermal treatment and hydrothermal treatment.

Tables 4A and 4B show that in the case of the granulated materials according to the invention G3-G5 the proportion of anatase increases only insignificantly during the thermal treatment and hydrothermal treatment.

Table 5 shows that in the case of the granulated materials according to the invention G3-G5 the average anatase crystallite size decreases only insignificantly on hydrothermal treatment.

The granulated materials of the invention thus display optimal properties for use as catalyst and catalyst support, namely a high stability of the pore volume, a high stability of the BET surface area and a high stability of the anatase phase which is relevant for catalytic processes.

TABLE 1
Mixed silicon-titanium oxide powders - starting materials

| | | P1 | P2 | P3 | P4 | P5 |
|---|---|---|---|---|---|---|
| SiO₂ | % by | 0 | 0.5 | 4.5 | 9.7 | 24.8 |
| | weight | | | | | |
| TiO₂ | % by | ≧99.8 | ≧99.3 | ≧95.3 | ≧90.1 | ≧75.0 |
| | weight | | | | | |
| BET | m²/g | 52 | 86 | 102 | 130 | 104 |
| Anatase | % | 77 | 71 | 73 | 85 | 69 |

TABLE 2A
Pore volume 2-50 nm on thermal treatment

| | |
|---|---|
| | According to the |
| Comparison | invention |

| | | G1 | G2 | G3 | G4 | G5 |
|---|---|---|---|---|---|---|
| 23° C. | cm³/g | 0.39 | 0.44 | 0.53 | 0.51 | 0.66 |
| 600° C. | cm³/g | 0.27 | 0.31 | 0.50 | 0.53 | 0.71 |
| 700° C. | cm³/g | 0.04 | 0.23 | 0.47 | 0.54 | 0.72 |
| 800° C. | cm³/g | 0.01 | 0.12 | 0.53 | 0.62 | 0.70 |
| 900° C. | cm³/g | — | 0.08 | 0.41 | 0.58 | 0.62 |

TABLE 2B
Pore volume 2-50 nm on hydrothermal treatment

| | |
|---|---|
| | According to the |
| Comparison | invention |

| | | G1 | G2 | G3 | G4 | G5 |
|---|---|---|---|---|---|---|
| 23° C. | cm³/g | 0.39 | 0.44 | 0.53 | 0.51 | 0.66 |
| 600° C. | cm³/g | 0.22 | 0.37 | 0.55 | 0.58 | 0.62 |
| 700° C. | cm³/g | 0.02 | 0.30 | 0.56 | 0.60 | 0.62 |
| 800° C. | cm³/g | 0.005 | 0.18 | 0.56 | 0.58 | 0.73 |
| 900° C. | cm³/g | — | 0.10 | 0.53 | 0.51 | 0.73 |

TABLE 3A
BET surface area on thermal treatment

| | |
|---|---|
| | According to |
| Comparison | the invention |

| | | G1 | G2 | G3 | G4 | G5 |
|---|---|---|---|---|---|---|
| 23° C. | m²/g | 52 | 86 | 102 | 130 | 104 |
| 600° C. | m²/g | 33 | 56 | 95 | 119 | 99 |
| 700° C. | m²/g | 9 | 31 | 90 | 115 | 94 |
| 800° C. | m²/g | 2 | 15 | 82 | 109 | 88 |
| 900° C. | m²/g | 0 | 10 | 67 | 96 | 82 |

TABLE 3B
BET surface area on hydrothermal treatment

| | |
|---|---|
| | According to |
| Comparison | the invention |

| | | G1 | G2 | G3 | G4 | G5 |
|---|---|---|---|---|---|---|
| 23° C. | m²/g | 52 | 86 | 102 | 130 | 104 |
| 600° C. | m²/g | 18 | 52 | 94 | 115 | 95 |
| 700° C. | m²/g | 8 | 31 | 90 | 114 | 91 |
| 800° C. | m²/g | 2 | 17 | 86 | 108 | 86 |
| 900° C. | m²/g | 0 | 10 | 76 | 93 | 82 |

TABLE 4A
Anatase content on thermal treatment

| | |
|---|---|
| | According to |
| Comparison | the invention |

| | | G1 | G2 | G3 | G4 | G5 |
|---|---|---|---|---|---|---|
| 23° C. | % | 77 | 71 | 73 | 85 | 69 |
| 600° C. | % | 54 | 59 | 78 | 86 | 67 |
| 700° C. | % | 0 | 35 | 76 | 81 | 67 |
| 800° C. | % | 0 | 0 | 76 | 81 | 69 |
| 900° C. | % | 0 | 0 | 73 | 85 | 69 |

TABLE 4B
Anatase content on hydrothermal treatment

| | |
|---|---|
| | According to the |
| Comparison | invention |

| | | G1 | G2 | G3 | G4 | G5 |
|---|---|---|---|---|---|---|
| 23° C. | % | 77 | 71 | 73 | 85 | 69 |
| 600° C. | % | 15 | 55 | 74 | 80 | 68 |
| 700° C. | % | 0 | 6 | 72 | 81 | 68 |
| 800° C. | % | 0 | 0 | 75 | 80 | 68 |
| 900° C. | % | 0 | 0 | 68 | 81 | 69 |

TABLE 5
Anatase crystallites - average size on hydrothermal treatment

| | |
|---|---|
| | According to the |
| Comparison | invention |

| | | G1 | G2 | G3 | G4 | G5 |
|---|---|---|---|---|---|---|
| 23° C. | nm | 21 | 15 | 16 | 11 | 13 |
| 600° C. | nm | 35 | 20 | 14 | 12 | 13 |
| 700° C. | nm | — | 35 | 14 | 12 | 13 |
| 800° C. | nm | — | — | 15 | 11 | 14 |
| 900° C. | nm | — | — | 16 | 13 | 14 |

1. A granulated material, comprising a mixed silicon-titanium oxide powder, wherein a proportion of titanium dioxide is from 70 to 98% by weight, a proportion of silicon dioxide is from 2 to 30% by weight, and a sum of the proportions of titanium dioxide and silicon dioxide is at least 98% by weight, in each case based on the granulated material, and wherein:
a) at room temperature
a1) the proportion of titanium dioxide comprises rutile and anatase, and a proportion of anatase, based on the titanium dioxide present, is more than 50%,
a2) the BET surface area of the granulated material is from 10 to 200 m²/g,
a3) the volume of pores having a size of from 2 to 50 nm of the granulated material is from 0.4 to 2.5 ml/g; and
b) after heating at 900° C. for a period of 4 hours,
b1) the proportion of anatase is more than 50% of the proportion at room temperature,
b2) the BET surface area is at least 60% of the BET surface area at room temperature, and
b3) the volume of pores having a size of from 2 to 50 nm is at least 50% of the volume of pores having a size of from 2 to 50 nm at room temperature.

2. The granulated material of claim 1, wherein the proportion of titanium dioxide is from 75 to 97% by weight, and the proportion of silicon dioxide is from 3 to 25% by weight, in each case based on the granulated material.

3. The granulated material of claim 1, wherein the proportion of anatase at room temperature is from 60 to 95%, based on the titanium dioxide present.

4. The granulated material of claim 1, wherein the BET surface area of the granulated material at room temperature is from 40 to 150 m²/g.

5. The granulated material of claim 1, wherein, after heating the granulated material at up to 900° C. for a period of 4 hours, the proportion of anatase is from 60 to 100% of the proportion at room temperature.

6. The granulated material claim 1, wherein, after heating the granulated material at up to 900° C. for a period of 4 hours, the BET surface area is from 65 to 85% of the BET surface area at room temperature.

7. The granulated material of claim 1, wherein, after heating the granulated material at up to 900° C. for a period of 4 hours, the volume of the pores having a size of from 2 to 50 nm is from ≧60 to 99% of the volume of the pores having a size of from 2 to 50 nm at room temperature.

8. The granulated material of claim 1, having an average granule diameter, D₅₀, from 10 to 200 μm.

9. A process for producing the granulated material of claim 1, the process comprising:
drying a dispersion or a solution comprising a mixed silicon-titanium oxide powder and water at a temperature from 100 to 350° C. for a period of 12 hours to 5 days, to obtain granulated material; and then
optionally, milling and sieving the granulated material, to obtain an average granule diameter, D₅₀, from 10 to 200 μm.

10. The process of claim 9, wherein the water is removed by spray drying.

11. The process of claim 9, wherein a proportion of the mixed powder in the dispersion is from 1 to 30% by weight.

12. The process of claim 9, wherein the aqueous solution further comprises a substance that lowers the viscosity of the solution.

13. The process of claim 9, wherein the mixed powder comprises a fumed mixed silicon-titanium oxide powder.

14. A catalyst or catalyst support comprising the granulated material of claim 1.

15. The granulated material of claim 1, wherein the proportion of titanium dioxide is from 85 to 95.5% by weight, and the proportion of silicon dioxide is from 4.5 to 15% by weight, in each case based on the granulated material.

16. The granulated material of claim 1, wherein the proportion of anatase at room temperature is from 60 to 85%, based on the titanium dioxide present.

17. The granulated material of claim 1, wherein, after heating the granulated material at up to 900° C. for a period of 4 hours, the proportion of anatase is from 65 to 99% of the proportion at room temperature.

18. The granulated material of claim 1, wherein, after heating the granulated material at up to 900° C. for a period of 4 hours, the volume of the pores having a size of from 2 to 50 nm is from 65 to 95% of the volume of the pores having a size of from 2 to 50 nm at room temperature.

19. The granulated material of claim 1, having an average granule diameter, D₅₀, from 10 to 40 μm.

20. The process of claim 9, comprising milling and sieving the granulated material, to obtain an average granule diameter, D₅₀, from 10 to 200 μm.
